(19) United States
(12) Patent Application Publication
(10) Pub. No.: US 2017/0270072 A1
(43) Pub. Date: Sep. 21, 2017

(54) BLADE TEST ACCESS MATRIX

(71) Applicant: Tollgrade Communications, Inc., Cranberry Twp., PA (US)

(72) Inventors: Raymond R. Gainar, Venetia, PA (US); Todd D. Wade, Bethel Park, PA (US); Roderick J. Warner, Mapledurwell (GB)

(73) Assignee: Tollgrade Communications, Inc., Cranberry Twp., PA (US)

(21) Appl. No.: 15/461,757

(22) Filed: Mar. 17, 2017

Related U.S. Application Data
(60) Provisional application No. 62/310,140, filed on Mar. 18, 2016.

(51) Int. Cl. G06F 13/40; G06F 13/36; G06F 13/42

(52) U.S. Cl. CPC G06F 13/4068; G06F 13/4282; G06F 13/36; G06F 13/409

(57) ABSTRACT

A system for providing access to subscriber lines includes a plurality of blade test access modules, including: a first blade test access module configured to engage with a first portion of a distribution frame. The first blade test access module includes first substrate, a plurality of first conductors positioned to engage with first terminals of the distribution frame, and one or more switches to control access to a first plurality of subscriber lines connected to the first terminals. The plurality of blade text access modules also includes a second blade test access module configured to engage with a second portion of the distribution frame. The second blade test access module includes a second substrate, a plurality of second conductors positioned to engage with second terminals of the distribution frame, and one or more switches to control access to a second plurality of subscriber lines connected to the second terminals.

### CROSS REFERENCE TO RELATED APPLICATION

This application claims the benefit of U.S. Provisional Application No. 62/310,140, filed Mar. 18, 2016, titled “BLADE TEST ACCESS MATRIX,” which is hereby incorporated by reference in its entirety.

### BACKGROUND

Various types of services, such as voice, video, and data services can be provided to customer premises through electrical conductors, termed “subscriber lines.” From time to time, a problem may arise with a service provided to a customer premises, and the problem may be reported to the service provider by the customer or detected by the service provider. The service provider may then initiate a test sequence to identify the source of the problem. In some cases, the test sequence may include testing the subscriber line leading to the customer premises. One way of testing the subscriber line is to connect a test device termed a “test head,” which can perform electrical testing on the subscriber line. The test head typically resides in the service provider network.

Electrical connections to subscriber lines can be made at an apparatus termed a “distribution frame.” A distribution frame may have a number of terminals for making connections to a corresponding number of subscriber lines. Distribution frames may exist at various locations in the service provider network, such as a central office or a cabinet. A cabinet may be located in a neighborhood, and may have a cabinet distribution frame having hundreds of terminals to provide connections to hundreds of subscriber lines leading to customer premises in the neighborhood. A central office distribution frame may have a larger number of terminals, such as tens of thousands, for example, to provide connections to subscriber lines in several neighborhoods. A switch network, connected between the test head and the terminals of the distribution frame, enables the test head to be connected to any desired subscriber line. A corresponding number of cables connects those terminals to the switch network.

### SUMMARY

Some embodiments relate to a system for providing access to subscriber lines, the system comprising: a plurality of blade test access modules, including: a first blade test access module configured to engage with a first portion of a distribution frame, the first blade test access module comprising a first substrate, a plurality of first conductors positioned to engage with first terminals of the distribution frame, and one or more switches to control access to a first plurality of subscriber lines connected to the first terminals; and a second blade test access module configured to engage with a second portion of the distribution frame, the second blade test access module comprising a second substrate, a plurality of second conductors positioned to engage with second terminals of the distribution frame, and one or more switches to control access to a second plurality of subscriber lines connected to the second terminals.

The first and second terminals of the distribution frame may be receptacles and the first and second conductors may be positioned on the first and second blade test access modules to plug into the first and second terminals of the distribution frame, respectively.

The system may further comprise an interconnection module, wherein the first blade test access module comprises at least one third conductor to engage with at least one first terminal of the interconnection module and the second blade test access module comprises at least one fourth conductor to engage with at least one second terminal of the interconnection module.

The interconnection module may comprise a processor configured to communicate to the first and second blade test access modules information identifying the order in which the first and second blade test access modules are connected to the interconnection module, and wherein the first and second blade test access modules are configured to save the information.

The interconnection module may be a first interconnection module, and the system may further comprise: a second interconnection module; and a serial bus connecting the first interconnection module and the second interconnection module.

Some embodiments relate to a method for installing a system for providing access to subscriber lines, the method comprising: engaging a first blade test access module with a first portion of a distribution frame, the first blade test access module comprising a first substrate, a plurality of first conductors positioned to engage with first terminals of the distribution frame, and one or more switches to control access to a first plurality of subscriber lines connected to the first terminals; and engaging a second blade test access module with a second portion of the distribution frame, the second blade test access module comprising a second substrate, a plurality of second conductors positioned to engage with second terminals of the distribution frame, and one or more switches to control access to a second plurality of subscriber lines connected to the second terminals.

The method may further comprise engaging the first and second blade test access modules with an interconnection module.

Engaging a first blade test access module with a first portion of a distribution frame may comprise plugging the first blade test access module into the first portion of the distribution frame and engaging a second blade test access module with a second portion of a distribution frame may comprise plugging the second blade test access module into the second portion of the distribution frame.

The interconnection module may be a first interconnection module, and the method further may further comprise connecting the first interconnection module to a second interconnection module.

The method may further comprise configuring the first and second blade test access modules.

The configuring may comprise receiving a store address command at the first blade test access module, incrementing an address field of the store address command and sending the incremented store address command to the second blade test access module

The method may further comprise connecting the first interconnection module to a test head.

Some embodiments relate to a method of configuring a test access system in which a plurality of blade test access modules are connected to a first interconnection module and plugged into a distribution frame, the method comprising: receiving a first configuration command at a first blade test access modules module, the first configuration command including a first address; the first blade test access module storing the first address; and the first blade test access module generating a second address based on the first address and sending a second configuration command to a second blade test access modules module including the second address.

Some embodiments relate to a method of operating a test access system in which a plurality of blade test access modules are connected to an interconnection module and plugged into a distribution frame, the method comprising: configuring the plurality of blade test access modules in response to a configuration command by propagating a configuration command successively through the plurality of blade test access modules, with a changing address value as the configuration command propagates through the blade test access modules of the plurality of blade test access modules, and, for each of the plurality of blade test access modules, storing, as an address of each of the plurality of blade test access modules, the address value of the configuration command that passes through the blade test access module; and opening a switch of a selected blade test access module of the plurality of blade test access modules in response to receiving a test access command including the address of the selected blade test access module.

The foregoing summary is provided by way of illustration and is not intended to be limiting.

### BRIEF DESCRIPTION OF THE DRAWINGS

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques described herein.

FIG. 1 shows a block diagram of a test system in which a plurality of blade test access modules (BTAMs) can be directly connected to columns of terminals of a distribution frame at a distribution frame panel, according to some embodiments.

FIG. 2A shows a distribution frame panel that provides connection terminals for a plurality of subscriber lines.

FIG. 2B illustrates the arrangement of BTAMs and an interconnection module when the BTAMs are plugged into the distribution frame.

FIGS. 3A and 3B show an interior side view and exterior end view respectively, of an exemplary blade test access module, also termed a “blade,” which is designed to be plugged into a column of the distribution frame panel.

FIG. 3C shows an example in which distribution frame connectors are formed by metal plated on protruding “fingers” of the PCB.

FIG. 3D shows another example of distribution frame connectors that are compressible to allow insertion into a receptacle on the distribution frame.

FIG. 3E shows a perspective view of the BTAM of FIG. 3D with an example of a housing.

FIGS. 4A and 4B show a side view and a top view, respectively, of an interconnection module that facilitates connections to a plurality of blade test access modules when they are engaged with the distribution frame.

FIG. 5 shows that blade test access modules each can be plugged into a corresponding column of the distribution frame.

FIG. 6 shows an example in which five blade test access modules are plugged into a panel of a distribution frame.

FIG. 7 shows a flowchart of an installation method, according to some embodiments.

FIG. 8 shows a flowchart of a configuration method, according to some embodiments.

FIG. 9 shows a flowchart of a test method, according to some embodiments.

FIGS. 10A-10C show various perspectives of an example of a design of the BTAM of FIG. 3E.

FIGS. 10D-10F showing various perspectives of an example of a design of an interconnection module.

### DETAILED DESCRIPTION

The inventors have recognized and appreciated techniques for providing test access to subscriber lines that reduce cost and increase the types of tests that can be performed. These test techniques may be performed using low cost modules, called blade test access modules (BTAMs), that are configured to interface to a distribution frame, providing selectable coupling of test signals between a test head and any of a number of subscriber lines from a distribution frame. This architecture avoids both the labor and material costs of cables as conventionally used for test access to a distribution frame in a cabinet. Each BTAM may include switches that pass relatively high frequency signals—for example, the switches may have cutoff or corner frequencies higher than 4 kHz, such as higher than 30 kHz, higher than 100 kHz, or higher than 250 kHz, and lower than 10 GHz, such as lower than 100 MHz, or lower than 10 MHz—enabling testing or measurement at such frequencies.

In some embodiments, multiple BTAMs may be used to provide a switch network for a single distribution frame. The BTAMs may be configured such that the switch network can be created without cabling between the BTAMs. In some embodiments, multiple BTAMs may be connected into a switch network through the use of a second type of module, termed an “interconnection module,” also termed a “sidecar.”

In some embodiments, these BTAMs have a simple and low cost design, yet have sufficient capabilities, alone or in combination with an interconnection module, to support one or more functions, including supporting an automated configuration process and/or responding to commands to provide test access to a specific subscriber line. In some embodiments, low cost may be achieved by implementing each BTAM as a printed circuit board (PCB), with conductors shaped and spaced to be plugged into a corresponding receptacle on the distribution frame and/or into a corresponding receptacle on the interconnection module. In some embodiments, the conductors that are plugged into a receptacle in the distribution frame are portions of the PCB or are disposed on the PCB.

In some embodiments, the BTAMs electrically and mechanically engage with a distribution frame. More specifically, in some embodiments the BTAMs are designed such that they can be directly plugged into the distribution frame. Each blade test access module may support connections to a plurality of subscriber lines, and may include circuitry for responding to commands to select a desired subscriber line for connection to a device of the service provider network, such as a test head, in response to a command Connecting a plurality of blade test access modules to the distribution frame can greatly facilitate making connections to subscriber lines, as the blade test access modules can avoid the need for a large number (e.g., hundreds) of cables connected to the distribution frame.

In some embodiments, the BTAMs electrically and mechanically engage with an interconnection module. The interconnection module may be designed such that the blade test access modules can be plugged into the interconnection module. Further, the interconnection module may be designed to provide mechanical support for the BTAM(s) when they are plugged into the distribution frame. Such an apparatus can facilitate interconnecting the BTAMs and can avoid the need for cables to interconnect the BTAMs. The interconnection module may, in some embodiments, create a plurality slots into which a BTAM may be plugged. Each slot may provide a connections to the BTAM, such as for test signals (which may be analog signals) used in testing a lint and control signals (which may be digital signals) that control operation of the BTAM. The interconnection module may comprise passive interconnects, which route test and/or control signals between adjacent BTAMs plugged into the slots, allowing communication over a limited number of cables to all of the BTAMs plugged into an interconnection module.

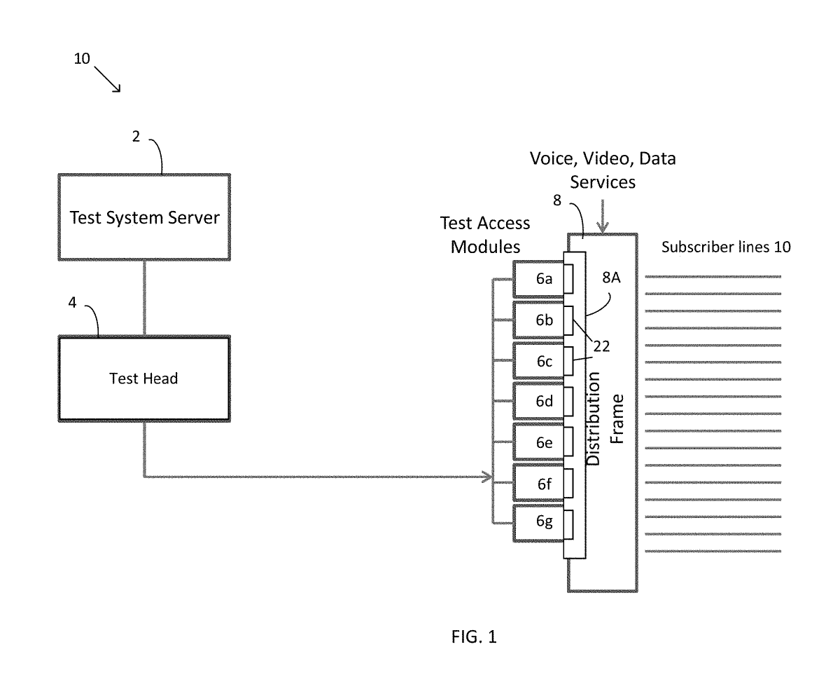

An embodiment of a test system will be described with reference to FIG. 1. FIG. 1 shows a block diagram of a test system 10 in which a plurality of blade test access modules 6 can be directly connected to columns 22 of terminals of a distribution frame 8 at a distribution frame panel 8A, according to some embodiments. Test system 10 includes a test system server 2, a test head 4, and a plurality of blade test access modules 6a-6g that can be plugged into the distribution frame 8 to facilitate making test connections to a plurality of subscriber lines 10. Test head 4 and/or another device may be configured to generate test access control signals to access a selected subscriber line.

The test system server 2 may be a computing device that resides in a service provider network, and may include a processor and suitable software and/or firmware. The test system server 2 may receive information regarding a subscriber line to be tested. For example, if a customer is experiencing a problem with telephone or digital subscriber line (DSL) service, the test system server 2 may receive a telephone number associated with the service and look up access information identifying the appropriate test head to test the subscriber line 10. The test access information may be stored in a database connected to the test system server 2, or may be stored in a separate system (e.g., in a database that stores provisioning information). The test system server may initiate a test sequence by commanding test head 4 to perform one or more tests on the subscriber line 10. The test sequence may be predetermined or may be determined based on results of one or more previously conducted tests.

Test head 4 communicates with a selected blade test access module 6 that controls access to the selected subscriber line 10. To identify the correct blade test access module 6, this information can be looked up in a database that stores mapping information regarding the customer's account to a corresponding blade test access module 6 and the port (i.e., switch) of the blade test access module that provides access to the selected subscriber line. The database storing the mapping information can be part of the test system, such as a database managed by server 2, or another system (e.g., a provisioning system). The test head 4 may then send a command to the blade test access module 6 with an address identifying the blade test access module 6 and port (i.e., switch) of the blade test access module 6 corresponding to the subscriber line desired to be accessed. The addressed blade test access module 6 may receive the command and turn on a switch connected to the appropriate terminal of the distribution frame 8 to open an electrical path from the test head 4 to the selected subscriber line 10.

The test head 4 may then perform one or more tests on the subscriber line by making measurements with or without applying electrical stimuli. Such tests may include DC tests, AC tests, time domain reflectometry (TDR) measurements, frequency domain reflectometry (FDR) measurements, or quite line noise (QLN) measurements, by way of example and not limitation.

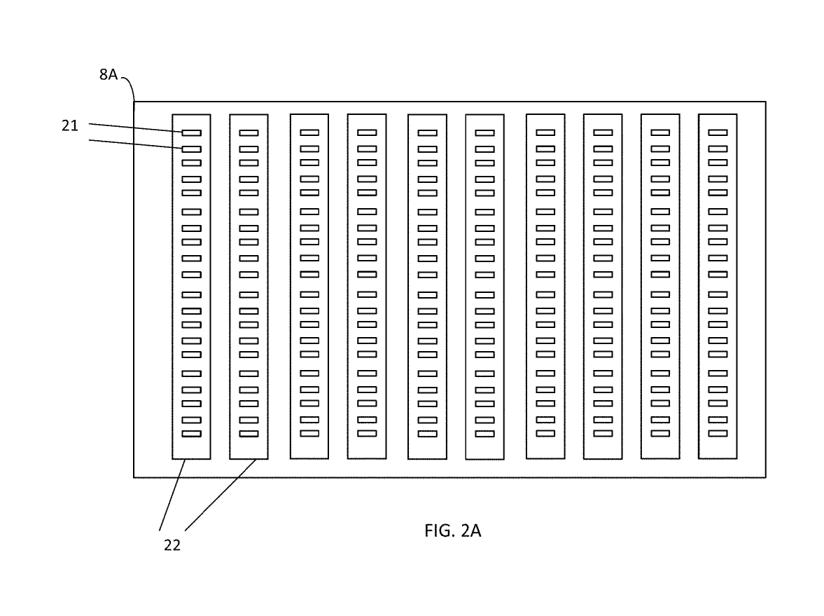

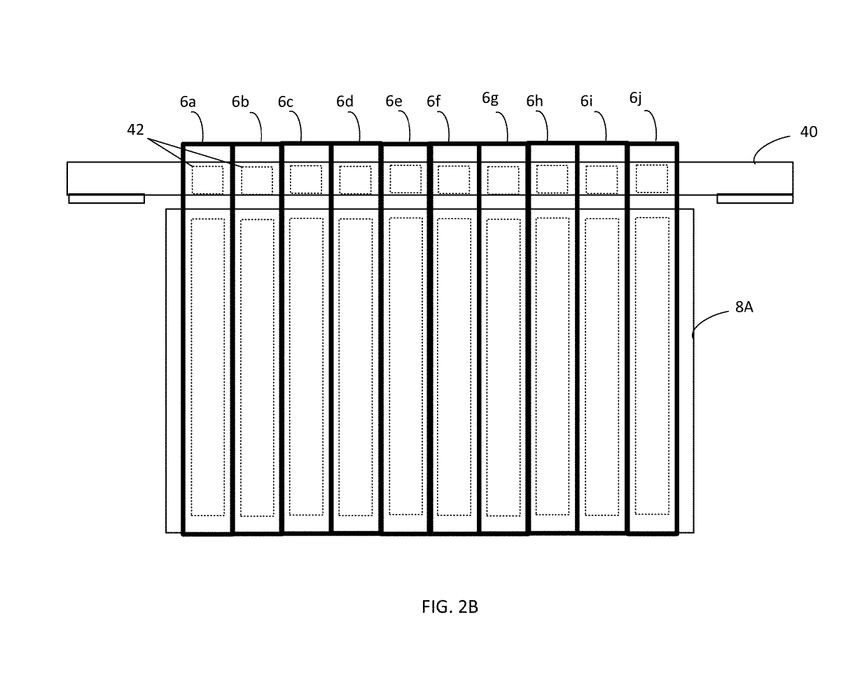

FIG. 2A shows a distribution frame panel 8A that provides connection terminals 21 for a plurality of subscriber lines. Distribution frame panel 8A has terminals 21 arranged in a matrix pattern with columns 22 extending vertically. In some embodiments, the connection terminals 21 may be connectors (e.g., receptacles) configured to mechanically and electrically engage with one or more inserted conductors. Although the terminals 21 are shown as having a long edge parallel to the horizontal dimension of FIG. 2A, terminals 21 may have any suitable shape and orientation. For example, the terminals 21 may be oriented such that they are perpendicular to the horizontal dimension of FIG. 2A. Alternatively, terminals 21 may not be elongated—e.g., they may be square, round or another shape having the same width in the vertical and horizontal dimensions.

In some embodiments, a subscriber line 10 may include a twisted-pair of conductors, and the distribution frame panel 8A may have a pair of connection terminals 21 for each subscriber line for connecting to each conductor of the twisted pair. By way of example, a distribution frame panel 8A may make connections to one hundred subscriber lines, as it may have ten columns 22, with each column 22 having ten pairs of connection terminals 21. According to prior techniques, one hundred cables would need to be connected to the distribution frame panel 8A to make connections to all one hundred subscriber lines. However, a distribution frame panel having connections to one hundred subscriber lines is merely an example, and it is appreciated that a distribution frame panel may have any suitable size or number of terminals.

FIG. 2B illustrates the arrangement of BTAMs and an interconnection module when the BTAMs are plugged into the distribution frame. A plurality of BTAMs 6 may be plugged into receptacles in respective columns 22 of the distribution frame panel 8A. The BTAMs 6 may be aligned vertically in the direction of the columns 22. The BTAMs may have a rigid housing, e.g., a plastic housing. The BTAMs 6 may be plugged into an interconnection module 40 at ports 42, as shown in FIG. 2B. Interconnection module 40 may have a rigid housing, as well, e.g., a plastic housing. As shown in FIG. 2B, interconnection module 40 may be perpendicular to the BTAMs. Each of the BTAMs and the interconnection module may have a printed circuit board (PCB) with circuitry (e.g., a microcontroller), to provide sufficient capabilities for configuration and testing, as discussed further herein. In some embodiments, the housing of the BTAMs and the interconnection module may provide a support structure for the PCBs.

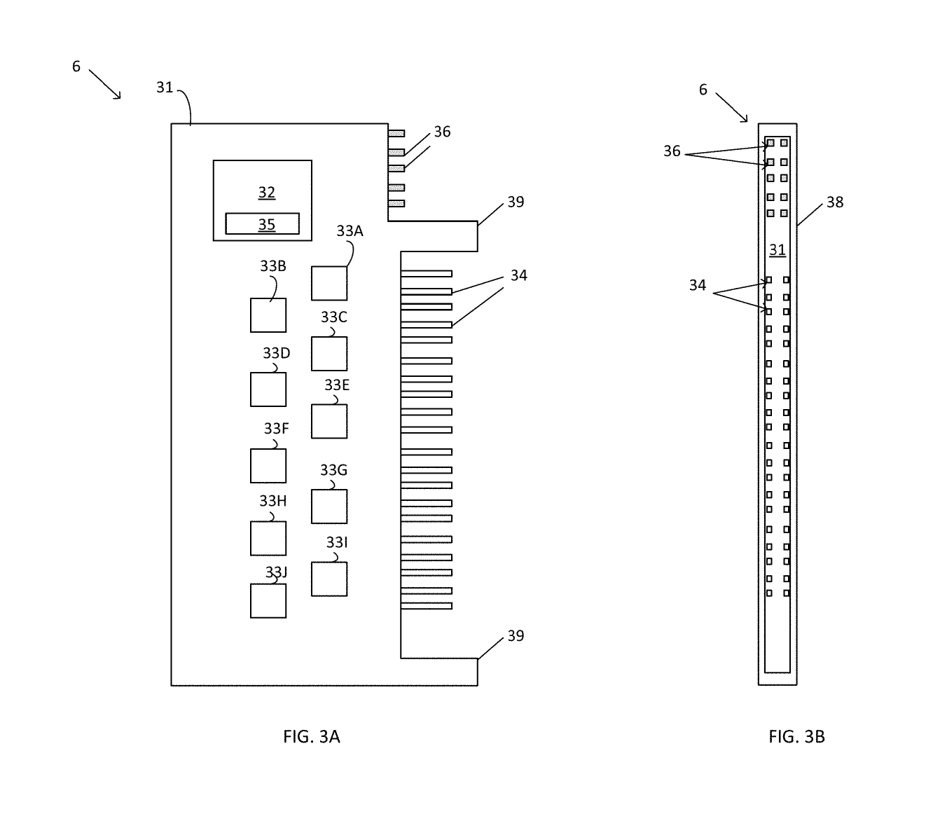

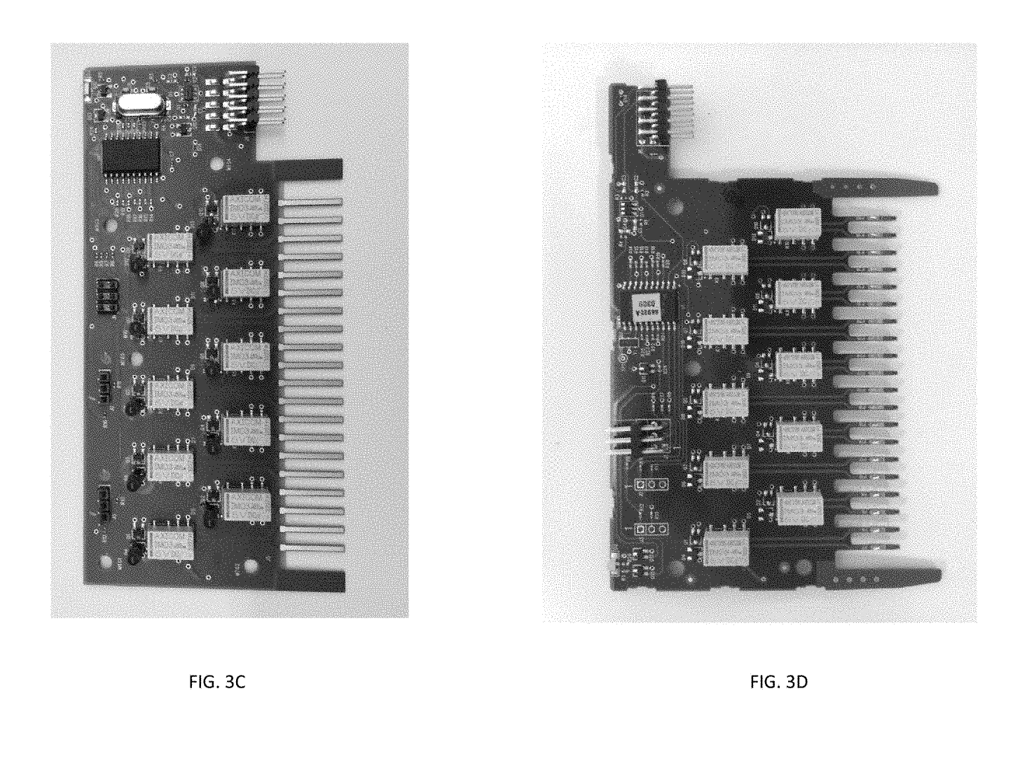

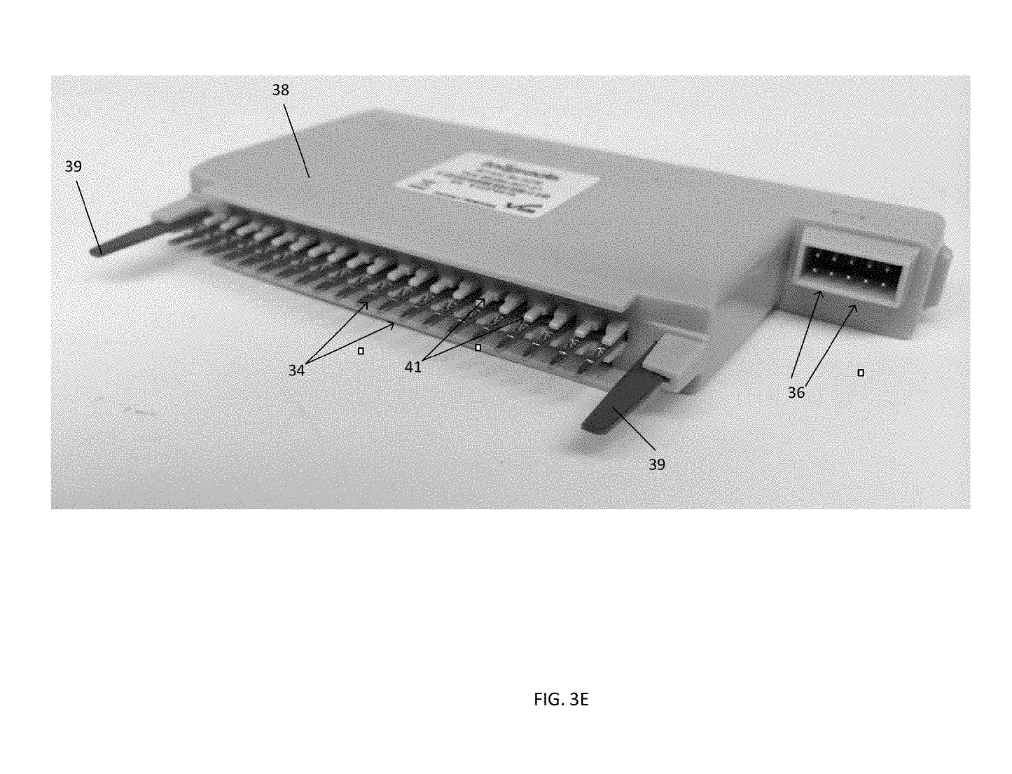

FIGS. 3A and 3B show an interior side view and exterior end view respectively, of an exemplary blade test access module 6, also termed a “blade,” which is designed to be plugged into a column 22 of the distribution frame panel 8A. Blade test access module 6 has a substrate 31, which may be a PC board (PCB) or another suitable substrate.

FIG. 3A shows the blade test access module 6 includes a plurality of distribution frame connectors 34 protruding from the substrate 31. The connectors 34 may be components, such as pins, attached to substrate 31. Alternatively, connectors 34 may be portions of substrate 31, with conductive pads on the surface, forming what is sometimes called a card-edge connector. To allow the connectors 34 to connect to the receptacles of the distribution frame, the connectors 34 have the same spacing as that of the connection terminals 21 along a column 22 of distribution frame panel 8A. The techniques described herein are not limited as to the size of the distribution frame panel, the number of subscriber line terminals it can accommodate, the number of columns in a distribution frame panel, or the number of terminals in a column of the distribution frame, as distribution frames may have various sizes, shapes and numbers of terminals. In the example of FIG. 3A, blade test access module 6 has ten pairs of distribution frame connectors 34 to connect to a distribution frame panel having ten pairs of receptacles for making connections to ten subscriber lines 10. However, this is merely by way of example. The number of distribution frame connectors may be equal to the number of terminals 21 in a column Alternatively, the number of distribution frame connectors may be fewer than the number of terminals 21 in a column, and the connections to the remaining terminals in the column may be made by another BTAM or by cable(s). The BTAM may also have protrusions 39, which may facilitate alignment of the BTAM with the distribution frame, and in some embodiments may provide mechanical support for the BTAM when it is plugged into the distribution frame. The protrusions 39 may be designed to fit into the guide slots of a receptacle of the distribution frame. In some embodiments, protrusions 39 may be portions of the substrate 31.

The blade test access module 6 also includes switches 33 to enable making connections to a selected pair of distribution frame connectors 34 corresponding to a selected subscriber line to be tested. In some embodiments, the switches 33 may be relays. When a switch 33 is closed, a connection between a selected pair of distribution frame connectors 34 is made to connectors 36 that connect to the interconnection module 40, which in turn is electrically connected to the test head 4, as discussed further below. In the embodiment of FIG. 3A, blade test access module 6 includes ten switches 33 (33A-33J) for controlling making connections to ten corresponding subscriber lines. However, the techniques described herein are not limited in this respect, as more or fewer switches may be used depending on the number of subscriber lines accommodated by a column 22 of the distribution frame panel. The blade test access module 6 also includes a plurality of connectors 36 for making connections to an interconnection module 40. In some embodiments, connectors 36 may be pins. As an example, the connectors 36 may be formed by a right-angle pin header mounted on the substrate. However, this is merely by way of example.

Blade test access module 6 also includes a processor 32. Processor 32 may have a programmable register 35 for storing configuration information, such as a programmable address, received from the interconnection module 40 and/or test head 4. The interconnection module 40 and/or test head 4 may issue one or more configuration commands to the BTAM 6 (e.g., as part of a configuration sequence). For example, the interconnection module 40 may determine the address of the BTAM 6 based on the port of the interconnection module 40 to which the BTAM is connected (which indicates the location at which it is connected to the distribution frame) and provide the address to the BTAM for storage in the programmable register 35. Alternatively, the BTAM may be configured manually.

As an example of another possible implementation, a BTAM may not store its address, as in some embodiments an interconnection module 40 may store the addresses of each BTAM plugged into the interconnection module 40 corresponding to respective ports 42 on the interconnection module 40. Such a BTAM may be accessed by the test head 4 by sending a command to the interconnection module 40, which controls the addressed BTAM in response to the test command (e.g., to open or close one or more switches).

As an example of a configuration sequence in which each BTAM determines and stores its own address, the test head 4 may issue one or more configuration commands directly to a first BTAM 6 among a plurality of BTAMs connected in a serial chain via one or more interconnection modules. The first BTAM may process that message and output another message to the next BTAM in the chain. Each BTAM in the chain may similarly output a message that acts as a command to the input of the next BTAM in the chain. In some embodiments, the first BTAM may obtain and store a first device address for itself from a received enumeration command from the test head 4. That BTAM may then increment the address and send an enumeration command containing the incremented address to the next BTAM in the chain. Each subsequent BTAM may assign and store an address based on the received enumeration command, modify the enumeration command with an incremented address before forwarding the modified enumeration command to the next BTAM in the chain. The assigned addresses are therefore dynamically determined every time an enumeration command is sent from the test head 4 to the first BTAM. Each address may be stored locally in each BTAM's register 35.

The enumeration command may be initiated manually or automatically in response to an event, for example after a power loss to restore the address values in BTAM registers. In another example, the enumeration command may be used to dynamically reconfigure the addresses after certain BTAM(s) are removed or replaced in the chain, providing flexibility. According to some embodiments, when no BTAM is plugged into a slot in the interconnection module, there may be a bridge device plugged into that slot to bridge the gap that would otherwise exist in a serial chain such that commands from the preceding BTAM is bridged directly to the subsequent BTAM in the chain in order to allow enumeration of addresses to propagate through the chain to all BTAMs. Alternatively or additionally, the enumeration command may be sent out periodically by the test head 4 as a measure for automatically restoring device addresses in events of potential power losses or device reconfigurations.

In one non-limiting example, when the test head 4 directly sends an enumeration command to BTAMs, each BTAM may return identification information to the test head upon receiving the enumeration command. The identification information may include the address, serial number, manufacturer, manufactured date, card type, port count, and any suitable information about each BTAM. The returned identification information about each BTAM may be used to indicate to the test head 4 whether there have been changes to the serial chain of BTAMs since the last enumeration. In some embodiments, by periodically sending the enumeration command and gathering the returned identification information, the test head may stay aware of the changes such as damages or replacements to the device array while keeping the BTAMs configured consistently.

To initiate a test operation, processor 32 may receive a communication from the test head 4 that is addressed to the BTAM 6. In response to the received communication, which may be a command to provide access to an identified subscriber line, the BTAM 6 may review the received communication and determine the action to be taken and/or other information, such as a port of the BTAM 6 corresponding to a subscriber line. If the received communication is a command to provide access to a selected subscriber line, the BTAM 6 may control the appropriate switch 33 to close, thereby connecting the test head 4 to the selected subscriber line. In some embodiments, the BTAM may send communications to the interconnection module 40 and/or test head 4. For example, the BTAM may send configuration status information indicating whether configuration is complete or switch status information indicating the status of its switches 33 (e.g., on or off).

In some embodiments, the blade test access module 6 may facilitate access to the subscriber line at frequencies higher than 4 kHz, such as higher than 30 kHz, higher than 100 kHz, or higher than 250 kHz, and lower than 1 GHz, such as lower than 100 MHz, or lower than 10 MHz. In some embodiments, the signal test path from the test head 4 to the subscriber lines allows testing or measurement at such high frequencies, in contrast to accessing the lines through a central office voice switch for testing, which may have switches of limited bandwidth that do not allow for testing or measurement at frequencies over 4 kHz. For example, frequency measurements such as FDR and/or QLN measurements of the subscriber line may be made at such frequencies. In some embodiments, high frequency access to the subscriber lines can facilitate diagnosing the source of a problem with a service, as it can allow testing to be performed at frequencies higher than could be performed previously due to the intervening switch network of limited bandwidth.

The distribution frame connectors 34 of the BTAM may be conductors shaped to plug into the distribution frame. The conductors may include a metal that is compatible with the metal conductors in the receptacles of the distribution frame. As one example, the receptacles of the distribution frame may be a 3M HDF SID-C connector, which has silver conductors. Accordingly, the distribution frame connectors may have conductors formed of silver or another metal compatible with silver. However, this is merely by way of example. In some embodiments, the distribution frame connectors 34 may be held firmly in the receptacles of the distribution frame, and provide mechanical support for the BTAMs. The conductors may be designed to provide an insertion pressure that makes the BTAMs easy to install, yet holds the BTAMs firmly in the distribution frame.

FIG. 3C shows an example in which distribution frame connectors 34 are formed by metal plated on protruding “fingers” of the PCB. The metal may be plated on both sides of the fingers, in some embodiments. However, any suitable metal may be used that is compatible with the metal of the distribution frame receptacles, such as copper, aluminum, gold, etc.

FIG. 3D shows another example of distribution frame connectors 34 that are compressible to allow insertion into a receptacle on the distribution frame. The conductive structures may be spring-loaded clips or may otherwise be constructed to produce an expansion force opposite the compressive force needed to insert the conductive structure into a receptacle. The expansion force produced by the conductive structures helps to hold the conductive structures in place in the receptacles of the distribution frame, and can provide mechanical support for the BTAM include spring-loaded clips that exert an expansion pressure against the receptacle. Such a design can facilitate holding the connectors firmly in the receptacles.

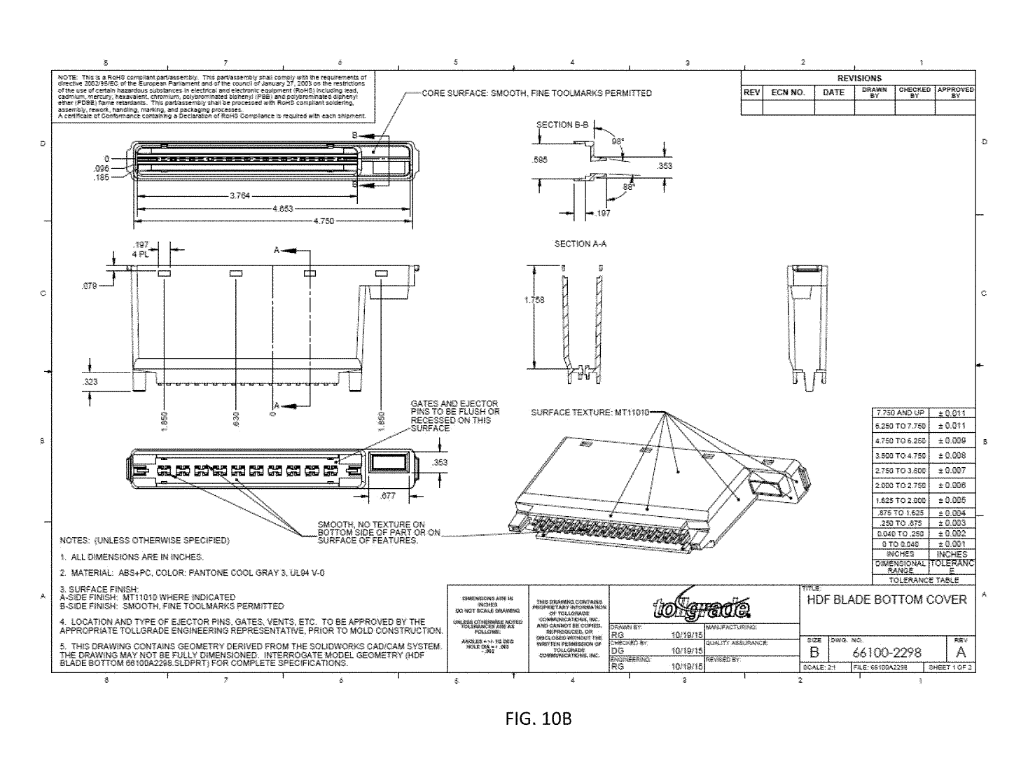

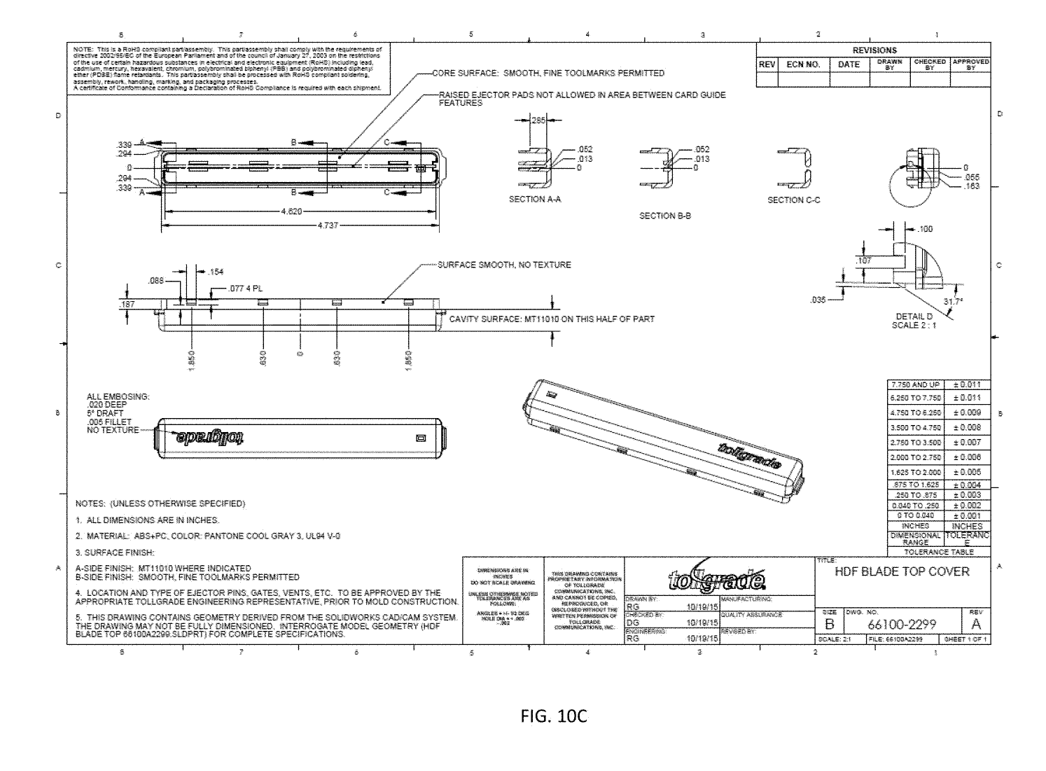

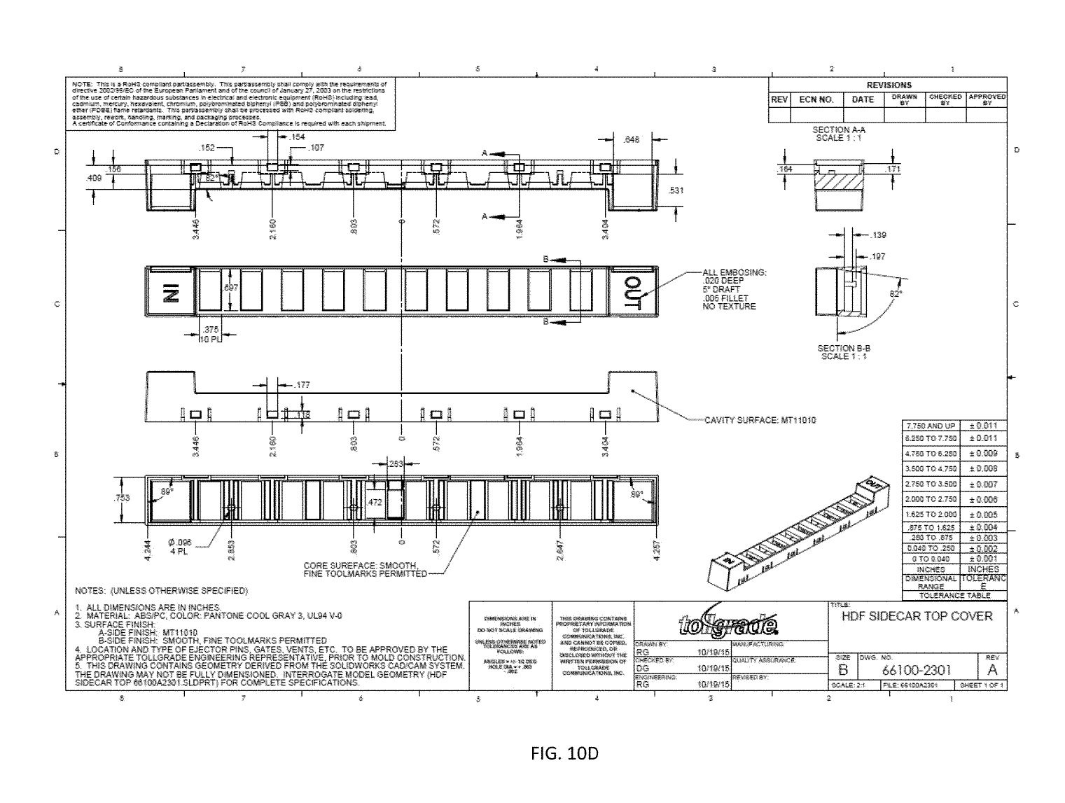

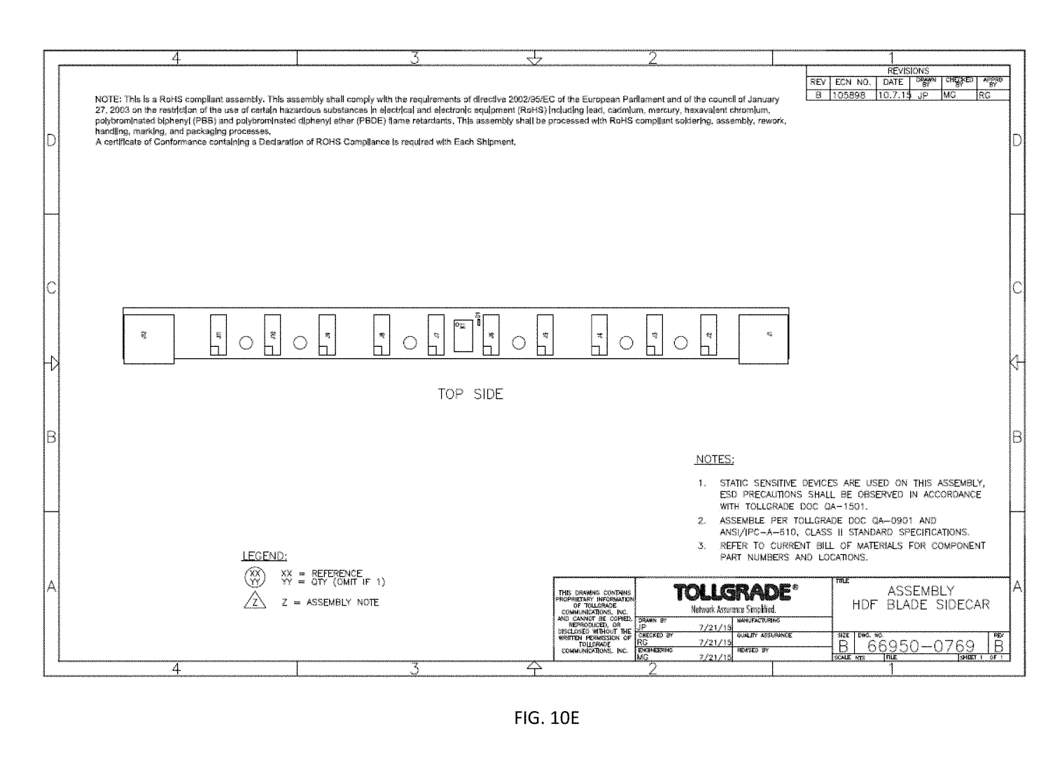

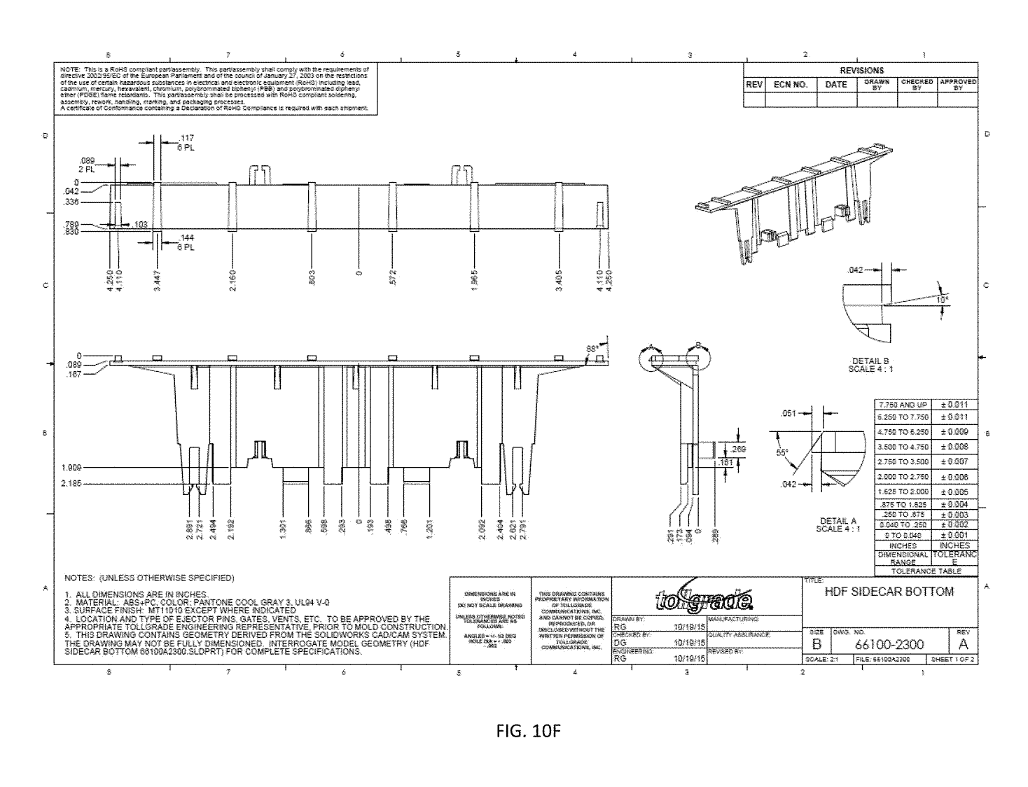

FIG. 3E shows a perspective view of the BTAM of FIG. 3D with an example of a housing 38. The housing 38 may have protrusions 41 aligned with connectors 34. Protrusions 41 may be formed on either side of a connector 34, as shown in FIG. 3C. Protrusions 41 may be designed fit firmly into a receptacle in the distribution frame and may provide mechanical support for the BTAM when it is plugged into the distribution frame. CAD drawings are provided in FIGS. 10A-10C showing various perspectives of an example of a design of the BTAM of FIG. 3E.

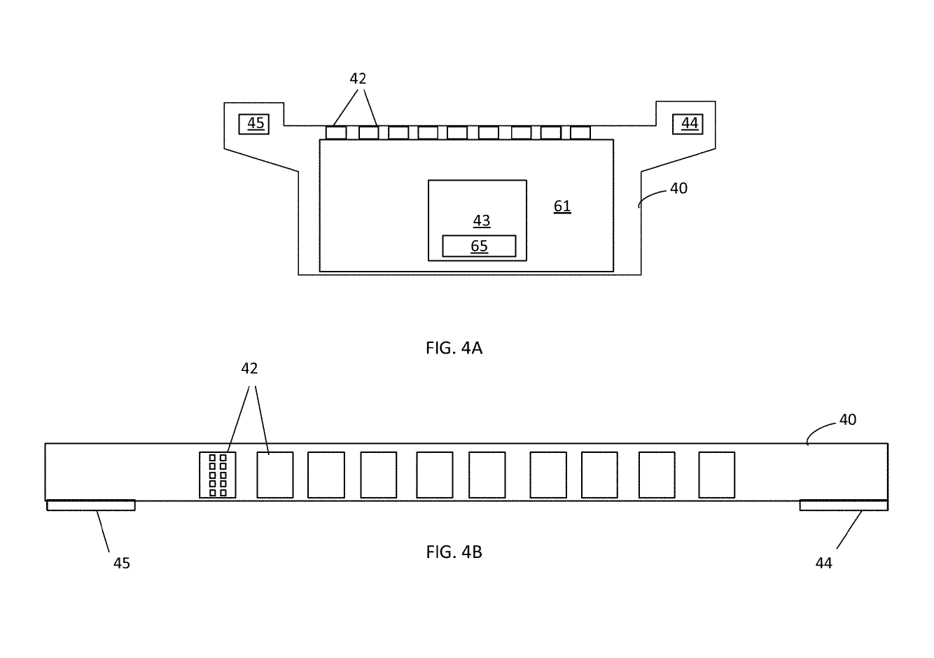

FIGS. 4A and 4B show a side view and a top view, respectively, of an interconnection module 40 that facilitates connections to a plurality of blade test access modules 6 when they are engaged with the distribution frame 8. Interconnection module 40 may include a substrate 61, such as a PCB, for example, as well as a processor 43 and configuration register 65 on the substrate 61. Interconnection module 40 includes a plurality of connection ports 42 to provide connections to a plurality of BTAMs. Each connection port 42 may have one or more receptacles (illustrated in the left-most connection port 42 in FIG. 4B) configured to receive the connectors 36 of the blade test access module 6. CAD drawings are provided in FIGS. 10D-10F showing various perspectives of an example of a design of an interconnection module 40.

To facilitate configuration, the interconnection module 40 may send commands to the BTAMs plugged into the interconnection module 40 to store their addresses, based on the position (port) at which they are connected to the interconnection module 40. The interconnection module 40 may send these commands to the BTAMs in response to a command from the test head 4, in response to a request from one or more BTAMs, or in response to a configuration sequence executed by the processor 43 of the interconnection module 40 or in response to a command from another interconnection module. Configuration of the BTAMs and/or interconnection module(s) may be coordinated by the test head 4, the interconnection module(s) and/or the BTAM(s). For example, the test head 4 may send a command to initiate a configuration sequence, which may be received by an interconnection module. The interconnection module may then send address configuration commands to the BTAM(s) plugged into the interconnection module based on their positions. The interconnection module may forward the command to initiate a configuration sequence to the next interconnection module. Alternatively, the test head 4 may send configuration commands addressed to one or more interconnection modules. As another example, an interconnection module may initiate a configuration sequence as part of a start-up sequence for the interconnection module (e.g., upon powering on the interconnection module).

To facilitate testing, processor 43 may examine the address of an incoming command and route the command to the appropriate blade test access module 6. However, such routing is optional, as in some embodiments the interconnection module 40 may provide received commands to all of the blade test access modules 6 to which it is connected, and the blade test access modules 6 may review all incoming commands Each blade test access module may take action in response to a command specifically addressed to that blade test access module.

To facilitate configuration of the blade test access modules 6, the processor 43 may provide information to the blade test access modules 6 indicating the order in which they are connected to the interconnection module 40. For example, if a blade test access module is connected to the first port 42 (e.g., the left-most port in FIGS. 4A and 4B), the interconnection module 40 may provide information to the blade test access module 6 connected to the first port 42 that it is connected to the first port. The processor 32 of blade test access module 6 may save this information (e.g., in a register or other storage) so that it will have awareness of what its address is in the interconnection module 40, and may review and act upon commands sent to its address.

The interconnection module 40 also includes connection ports 44 and 45 for making a connection to test head 4 and optionally making a connection to another interconnection module 40.

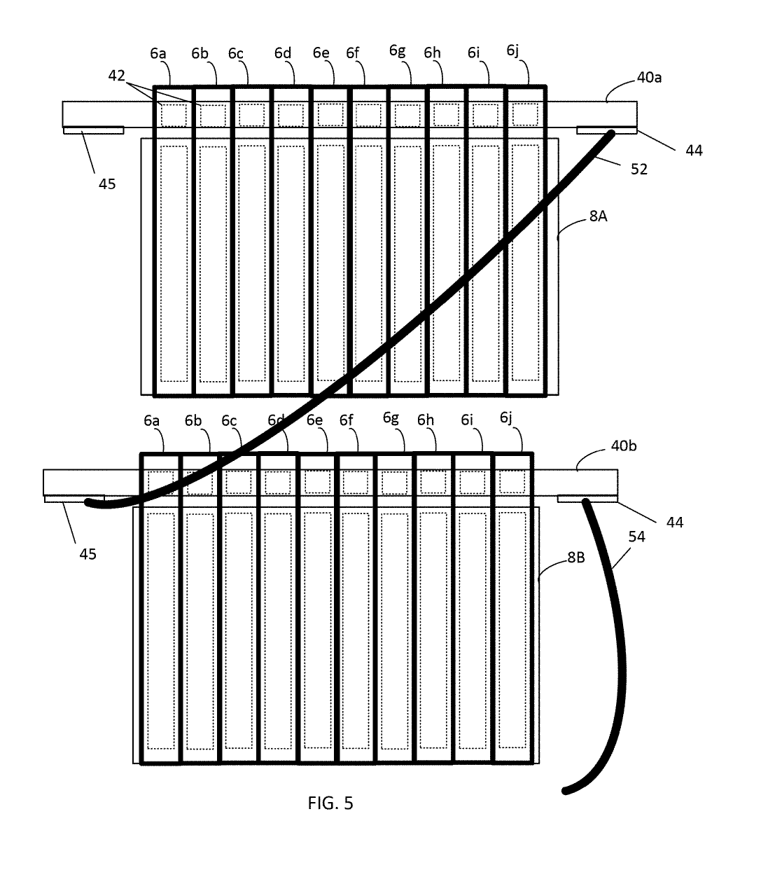

FIG. 5 shows that blade test access modules 6 each can be plugged into a corresponding column 22 of the distribution frame. In this example, each distribution frame panel 8A, 8B accommodates ten blade test access modules 6. FIG. 5 also shows that each of the blade test access modules 6 is plugged into a port 42 of the interconnection module 40a or 40b. As shown, the interconnection modules 40a and 40b are positioned against the distribution frame 8 with the top of the interconnection modules facing out, so that the receptacles of ports 42 are positioned to accept connectors 36. Advantageously, such a configuration allows the blade test access modules 6 to be plugged into the distribution frame 8 and an interconnection module 42 at the same time.

The interconnection modules may be chained together in series, with cables connecting adjacent interconnection modules in the chain. Such an embodiment is illustrated in FIG. 5. A cable 54 may connect port 44 of interconnection module 8B with the test head 4. In some embodiments, the cable may have two pairs of wires for command/control, two wires for power, and two wires for the test signal. However, the techniques described herein are not limited to the cable used or the number of conductors in the cable. In some embodiments, a cable 52 may connect interconnection modules to one another. Cable 52 may include a serial bus in some embodiments. Cable 52 may be connected to a port 44 (e.g., an input port) of one interconnection module and port 45 (e.g., an output port) of another interconnection module, and additional interconnection modules may be chained by connecting the output port of one interconnection module to the input port of another interconnection module.

In some embodiments, circuitry within each interconnection module implementing a “daisy chain” in which command or data received by one module is used by that module if intended for it or passed on to the next module in the chain if not. When interconnection modules are chained in this manner, the processors 43 of the interconnection modules may communicate with one another to identify their relative positions in the chain. For example, each interconnection module may receive information from the previous interconnection module in the chain indicating its position, and store this value (e.g., in a register or other storage). The interconnection module may then increment the value by one and forward the incremented value for the next position in the chain to the next interconnection module. Accordingly, just as the blade test access modules 6 may be aware of and store their relative position with respect to an interconnection module 40, each interconnection module may be aware of and store its position with respect to the chain of interconnection modules. This can allow the test head 4 to communicate with the interconnection modules and/or blade test access modules based upon the distribution frame panel to which they are connected, as each interconnection module may be dedicated to each a distribution frame panel.

In some embodiments separate cables may connect the test head 4 to each interconnection module, which may eliminate the need for interconnection modules to communicate with one another.

In some embodiments, a combination of connections may be used, with some interconnection modules being chained together, and other module(s) or groups of module(s) may have separate cables for connections to the test head 4. For example, a first cable from the test head may connect to a first interconnection module of a first group of chained interconnection modules, and a second cable from the test head may connect to a first interconnection module of a second group of chained interconnection modules.

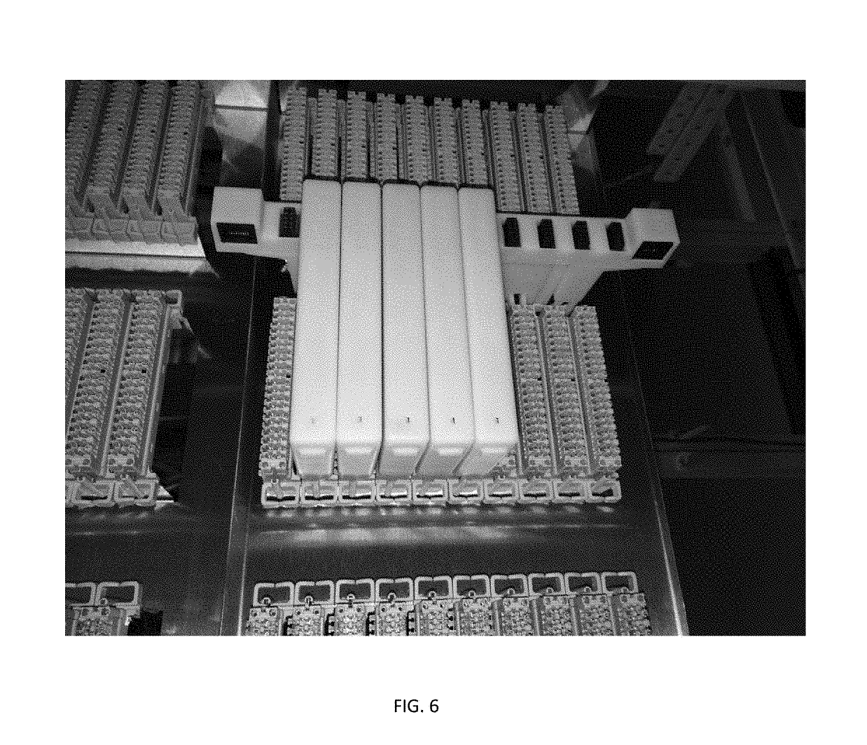

FIG. 6 shows a photograph in which five blade test access modules 6 are plugged into a panel of a distribution frame. FIG. 6 also shows the blade test access modules 6 are plugged into an interconnection module 40. As shown, the blade test access modules 6 and interconnection module may have a housing which may be formed of any suitable material, such as plastic, for example. The housings provide mechanical support for the PCBs of the BTAMs and interconnection module.

In some embodiments, and as illustrated in FIG. 3A and FIG. 6, the substrate 31 and/or connectors 36 may be shaped and/or positioned to allow space for the interconnection module 40 when the BTAM is plugged into the distribution frame. For example, the connectors 36 may extend outward from the substrate 31 a smaller distance than connectors 34, in order to accommodate the interconnection module 40. The BTAM and interconnection modules may be designed to hold multiple BTAMs in a configuration that conforms to a standard distribution frame. For example, the BTAMs attached to one interconnection module may provide connections to 100 subscriber lines, arranged in a 10x10 array conforming to the shape of a connector block in a standard distribution frame. However, any suitable number and arrangement of connections points may be provided.

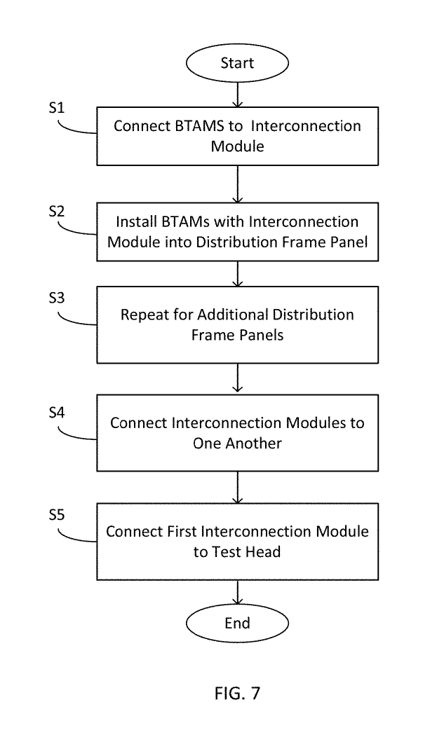

FIG. 7 shows a flowchart of an installation method, according to some embodiments. In step S1, the BTAMs for a panel of the distribution frame are connected to the interconnection module. In some embodiments, the BTAMs may be plugged into the interconnection module. In step S2, the BTAMs and interconnection module are installed into the distribution frame. For example, the BTAMs may be aligned with the distribution frame panel and then plugged into the distribution frame panel. However, in some embodiments BTAMs are not plugged into the interconnection module before being installed into the distribution frame. For example, in some embodiments an interconnection module may be secured on the distribution frame and then the BTAMs may be plugged into the interconnection module and distribution frame while the interconnection module is secured at the distribution frame panel.

In step S3, the steps of connecting the BTAMs to the interconnection frame panel and installing them into the distribution frame may be performed for the additional panels of the distribution frame.

In step S4, the interconnection modules may be connected to one another. For example, cables may be installed between respective interconnection modules to interconnect them. However, in some embodiments at least some of the interconnection modules are not connected to one another. For example, cables may be installed to connect interconnection modules to the test head.

In step S5, for any sets of interconnection modules chained together, the first interconnection module may be connected to the test head. For example, a cable may be installed to connect the first interconnection module to the test head. In some embodiments, the order of steps S4 and S5 may be reversed, as connections between interconnection modules and between an interconnection module and the test head may be made in any order.

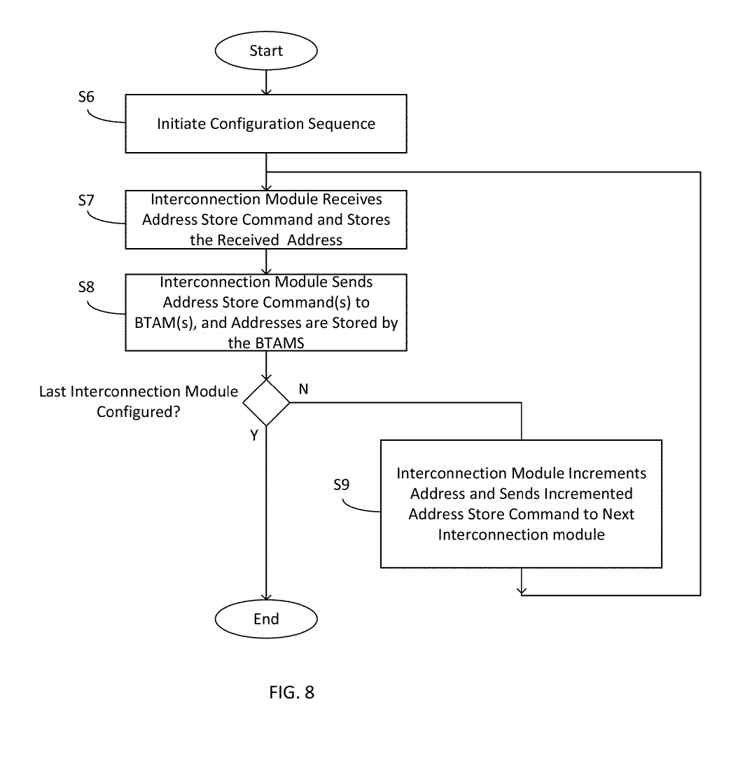

FIG. 8 shows a flowchart of a configuration method, according to some embodiments. The configuration method of FIG. 8 may be performed after the installation method of FIG. 7. FIG. 8 illustrates a scenario in which the interconnection modules contain processing components that may enable an address to be assigned to each interconnection module in the same way that a serial assignment process is described above for assigning addresses to BTAM modules. However, it should be appreciated that, in some embodiments, a separate connection may be made between test head 4 and each interconnection module such that there is no need for addressable hardware in the interconnection modules.

In embodiments in which interconnection modules include configurable, addressable hardware, in step S6, a configuration sequence is initiated. In some embodiments, the configuration sequence is initiated by the test head 4 sending a command to the first interconnection module in a chain of interconnection modules. As discussed above, the test head 4 may send a store address 0 command to the first interconnection module in the chain, which commands the first interconnection module to store the first address. In step S7, the first interconnection module receives the store address 0 command and stores address 0 in a configuration register 65. However, the techniques described herein are not limited to the test server 4 initiating the configuration sequence, as in some embodiments the configuration sequence may be initiated by configuration software and/or firmware running on a processor of an interconnection module or BTAM.

In some embodiments, after the interconnection module is configured, the interconnection module and/or the test head may then configure the BTAM(s) connected to the test module in step S8. For example, in some embodiments the interconnection module may send address store commands to each of the BTAM(s) plugged into the interconnection module, with unique addresses. The BTAM(s) may then store the received addresses in suitable storage, such as register 35. The address store commands for the BTAM(s) may be generated either by the interconnection module or the test head.

If the interconnection module is not the last interconnection module it the chain, it may then send a configuration command to the next interconnection module in the chain in step S9. In some embodiments, the interconnection module may increment the address it received in the address store command by one, and forward it to the next interconnection module. For example, the first interconnection module in the chain may increment the “0” address it received by one and send a store address 1 command to the next interconnection module in the chain. The next interconnection module and its BTAMs are then configured in steps S7 and S8, and the sequence repeats until the last interconnection module in the chain has been configured. In this way, each of the BTAMs may be assigned an address, dynamically, without any a priori knowledge of how the BTAMs are connected to the distribution frame. Nonetheless, the addresses are automatically assigned with a correspondence between specific BTAMs and specific connection points on the distribution frame, enabling a specific subscriber line to be accessed for testing by appropriately addressing commands to the BTAMs.

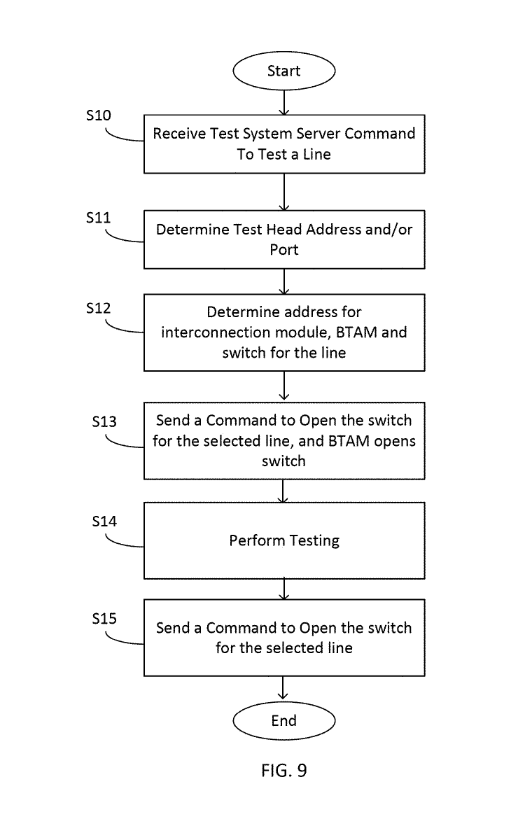

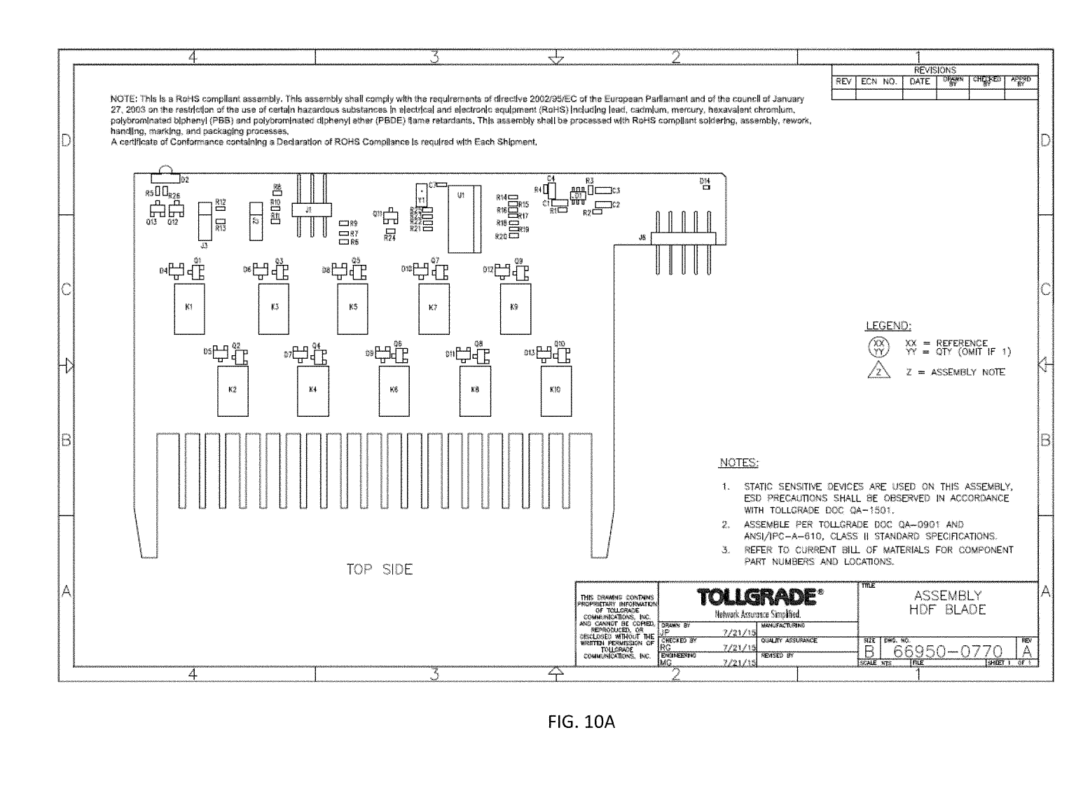

FIG. 9 shows a flowchart of a test method, according to some embodiments. In step S10, a command may be received by test system server 2 to test a line. In step S11, the test head 4 address and port for the line may be determined (e.g., by test system server 2). In step S12, the address for the interconnection module, BTAM and BTAM switch for the selected line may be looked up in a database of the test system or another system, such as a provisioning system. Step S12 may be performed by the test head, the test system server 2, or another device. In step S13, the test head 4 sends a command to activate the switch for the selected line. For example, the test head 4 may send a command addressed to the interconnection module and BTAM connected to the selected line, to open the corresponding switch 33. In response, the BTAM opens the corresponding switch. However, it should be appreciated that, depending on the wiring of the BTAM and/or distribution frame, activation of the switch may entail closing the switch. Moreover, in some embodiments, switches may be compound, such that activating a switch entails opening and/or closing multiple switches. Testing is then performed in step S14. For example, the test head may measure signals on the selected line, or may generate test signals on the selected line and measure the response. When testing is completed, the test head may send a signal to the interconnection module and BTAM connected to the selected line, to close the corresponding switch 33 in step S15. In response the BTAM then closes the switch.

### Additional Aspects

As used herein use of the term “subscriber line” does not require the lines be in service, or connected to the subscriber premises. Generally, subscriber lines run from a service provider network toward subscriber premises.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

For example, the BTAMs and interconnection modules are described to be enclosed within plastic housings. Such housings may protect as well as mechanically support the components. However, it is not required that the support structure be plastic or that each BTAM and/or interconnection module have its own housing. In some embodiments, a frame or other support members may hold multiple BTAMs. Further, the housing or other support structure may have features in addition to those shown herein. For example, latches, hubs, bosses and/or other features may be included to mechanically interconnect the housings or other support members.

As another example, embodiments of controllers may be implemented using hardware, software or a combination thereof. When implemented in software, the software code can be executed on any suitable hardware processor or collection of hardware processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed to perform the functions recited above.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A system for providing access to subscriber lines, the system comprising:
a plurality of blade test access modules, including:
a first blade test access module configured to engage with a first portion of a distribution frame, the first blade test access module comprising a first substrate, a plurality of first conductors positioned to engage with first terminals of the distribution frame, and one or more switches to control access to a first plurality of subscriber lines connected to the first terminals; and
a second blade test access module configured to engage with a second portion of the distribution frame, the second blade test access module comprising a second substrate, a plurality of second conductors positioned to engage with second terminals of the distribution frame, and one or more switches to control access to a second plurality of subscriber lines connected to the second terminals.

2. The system of claim 1, wherein the first and second terminals of the distribution frame are receptacles and the first and second conductors are positioned on the first and second blade test access modules to plug into the first and second terminals of the distribution frame, respectively.

3. The system of claim 1, further comprising an interconnection module, wherein the first blade test access module comprises at least one third conductor to engage with at least one first terminal of the interconnection module and the second blade test access module comprises at least one fourth conductor to engage with at least one second terminal of the interconnection module.

4. The system of claim 3, wherein the interconnection module comprises a processor configured to communicate to the first and second blade test access modules information identifying the order in which the first and second blade test access modules are connected to the interconnection module, and wherein the first and second blade test access modules are configured to save the information.

5. The system of claim 3, wherein the interconnection module is a first interconnection module, and the system further comprises:
a second interconnection module; and
a serial bus connecting the first interconnection module and the second interconnection module.

6. A method for installing a system for providing access to subscriber lines, the method comprising:
engaging a first blade test access module with a first portion of a distribution frame, the first blade test access module comprising a first substrate, a plurality of first conductors positioned to engage with first terminals of the distribution frame, and one or more switches to control access to a first plurality of subscriber lines connected to the first terminals; and
engaging a second blade test access module with a second portion of the distribution frame, the second blade test access module comprising a second substrate, a plurality of second conductors positioned to engage with second terminals of the distribution frame, and one or more switches to control access to a second plurality of subscriber lines connected to the second terminals.

7. The method of claim 6, further comprising engaging the first and second blade test access modules with an interconnection module.

8. The method of claim 6, wherein engaging a first blade test access module with a first portion of a distribution frame comprises plugging the first blade test access module into the first portion of the distribution frame and engaging a second blade test access module with a second portion of a distribution frame comprises plugging the second blade test access module into the second portion of the distribution frame.

9. The method of claim 8, wherein the interconnection module is a first interconnection module, and the method further comprises connecting the first interconnection module to a second interconnection module.

10. The method of claim 9, further comprising configuring the first and second blade test access modules.

11. The method of claim 10, wherein the configuring comprises receiving a store address command at the first blade test access module, incrementing an address field of the store address command and sending the incremented store address command to the second blade test access module

12. The method of claim 7, further comprising connecting the interconnection module to a test head.

13. A method of configuring a test access system in which a plurality of blade test access modules are connected to a first interconnection module and plugged into a distribution frame, the method comprising:
receiving a first configuration command at a first blade test access modules module, the first configuration command including a first address;
the first blade test access module storing the first address; and
the first blade test access module generating a second address based on the first address and sending a second configuration command to a second blade test access modules module including the second address.

14. A method of operating a test access system in which a plurality of blade test access modules are connected to an interconnection module and plugged into a distribution frame, the method comprising:
configuring the plurality of blade test access modules in response to a configuration command by propagating a configuration command successively through the plurality of blade test access modules, with a changing address value as the configuration command propagates through the blade test access modules of the plurality of blade test access modules, and, for each of the plurality of blade test access modules, storing, as an address of each of the plurality of blade test access modules, the address value of the configuration command that passes through the blade test access module; and
opening a switch of a selected blade test access module of the plurality of blade test access modules in response to receiving a test access command including the address of the selected blade test access module.
